(19) United States
(12) Patent Application Publication
(10) Pub. No.: US 2024/0125617 A1
(43) Pub. Date: Apr. 18, 2024

(54) Aggregation of Data Representing Geographical Areas

(71) Applicant: Motional AD LLC, Boston, MA (US)

(72) Inventors: Apoorv Singh, Carnegie, PA (US); Varun Kumar Reddy Bankiti, Boston, MA (US); Jeongil Ju, Santa Monica, CA (US); Akankshya Kar, Santa Monica, CA (US)

(21) Appl. No.: 18/091,786

(22) Filed: Dec. 30, 2022

Related U.S. Application Data
(60) Provisional application No. 63/416,463, filed on Oct. 14, 2022.

(51) Int. Cl. G01C 21/00; G01C 21/36; G06T 11/00; G08G 1/01; G08G 1/056

(52) U.S. Cl. CPC G01C 21/3841; G01C 21/3667; G06T 11/00; G08G 1/0125; G08G 1/0141; G08G 1/056

(57) ABSTRACT

Provided are methods and systems for aggregating data associated with various geographic areas for trajectory determination and high definition map generation. The methods and systems may include obtaining first data associated with a first area that is external to a vehicle, converting the first data associated with the first area from a first format to a second format, transmitting the first data that is converted and a query associated with a second area, receiving second data specific to the second area responsive to the query, aggregating the second data specific to the second area with the first data, determining, using the at least one processor, a trajectory of the vehicle within a physical space based on the aggregating of the second data with the first data, and/or generating a graphical representation for use by a display of the vehicle based on the second data that is aggregated with the first data.

### CROSS REFERENCE TO RELATED APPLICATION

This application claims priority under 35 U.S.C. § 119(e) to, U.S. Provisional Application No. 63/416,463 filed Oct. 27, 2022, titled “GRAPHICAL REPRESENTATION GENERATION BASED ON AGGREGATION OF PROCESSED DATA OF GEOGRAPHICAL AREAS”, the subject matter of which is hereby incorporated by reference in its entirety.

### BACKGROUND

Vehicles, such as autonomous vehicles, use sensors to detect data of various objects within a particular vicinity of their surrounding environment and use this data to generate high definition maps for navigation. Further, autonomous vehicles may access data from various sources that are external to these vehicles to assist in navigation.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 depicts an example embodiment of a system configured to aggregate processed data of various geographical areas for the purpose of determining a trajectory of a vehicle within a physical space and generating one or more graphical representations for use by a display of a vehicle;

FIG. 6A depicts an example implementation of the system of the present disclosure in which two vehicles obtain and process data of different geographical areas, according to one or more embodiments described and illustrated herein;

FIG. 6B depicts an example embodiment in which a vehicle transmits a query and receives a response that enables determination of information regarding objects beyond a field of view of the vehicle's cameras, according to one or more embodiments described and illustrated herein;

FIG. 7 depicts an example of a high definition map that is generated and output on a display of a vehicle; and

FIG. 8 is a flowchart of a process for aggregating processed data of various geographical areas for the purpose of determining a trajectory of a vehicle within a physical space and generating one or more graphical representations for use by a display of the vehicle

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as is needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Aspects and/or embodiments, systems, methods, and computer program products described herein involve a vehicle that determines a trajectory of the vehicle within a physical space and generates a map based on an aggregation of data regarding a portion of a street visible to the vehicle and data regarding a portion of the street not visible to the vehicle. The generated map enables a first vehicle to identify objects that are inaccessible to or beyond the visual range of the cameras of the first vehicle, e.g., pedestrians located around a corner of a building. The processing of data, which occurs locally at each vehicle (e.g., including the first vehicle) prior to transmission to the server or one or more additional vehicles, includes a step of converting the captured data from, e.g., a JPEG, RAW, or PNG formats, to particular numerical representations, e.g., float values. Float values are numbers or numerical representations that are utilized to describe characteristics of one or more objects included in the image data associated with the images. In aspects, float values are representative of or characterize positions, orientations, and various attributes of an object in an image, a video stream, and so forth. In aspects, the float values are representative of coordinates (e.g., x, y, z coordinates) of an object, width and length of the object, and so forth. In aspects, objects included in the captured images are, e.g., pedestrians, buildings, traffic lights, traffic signs, and so forth. The float values are also representative of velocities of an object in the x, y, or z direction. Further, the data regarding the portion of the street not visible to the vehicle is obtained from an external resource such as a server, which in turn may have obtained the data from a second vehicle that previously traveled in the vicinity of that portion of the street. Alternatively, in some embodiments, the first vehicle obtains data regarding the portion of the street not visible to the first vehicle directly from the second vehicle, which operates to convert image data that is captured of an area within a proximity of the second vehicle into float values. These float values are then transmitted by the second vehicle directly to the first vehicle.

By virtue of the implementation of systems, methods, and computer program products described herein, techniques for determining a trajectory of a vehicle within a physical space and generating one or more graphical representations for use by a display of a vehicle, e.g., based on aggregation of processed data of various geographical areas provide numerous advantages. Some of these advantages include enabling vehicles to determine a travel trajectory and generate, in real time, accurate high definition (“HD”) maps of areas that are beyond the visual range of and/or inaccessible to the cameras disposed on these vehicles, for example, while avoiding blind spots, occlusions, and various network inaccuracies. Additionally, the step of processing of the captured data locally by each vehicle prior to the transmission of the data facilitates the efficient sharing (among vehicles) of large amounts of information regarding objects present in various geographic areas. In particular, the processing of the captured data involves the step of converting the data captured by cameras (e.g., from image data format to float values). Such a conversion facilitates resource efficient data sharing. Further, the implementation of systems, methods, and computer program products described herein enables for the sharing of image data in a unified data structure, namely in the form of float values representing data of objects, maps, and so forth.

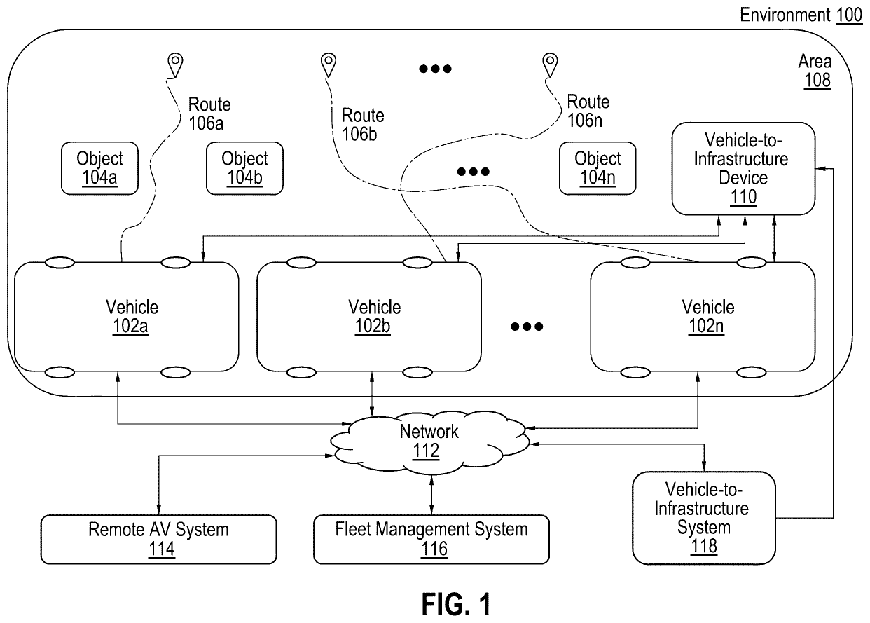

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

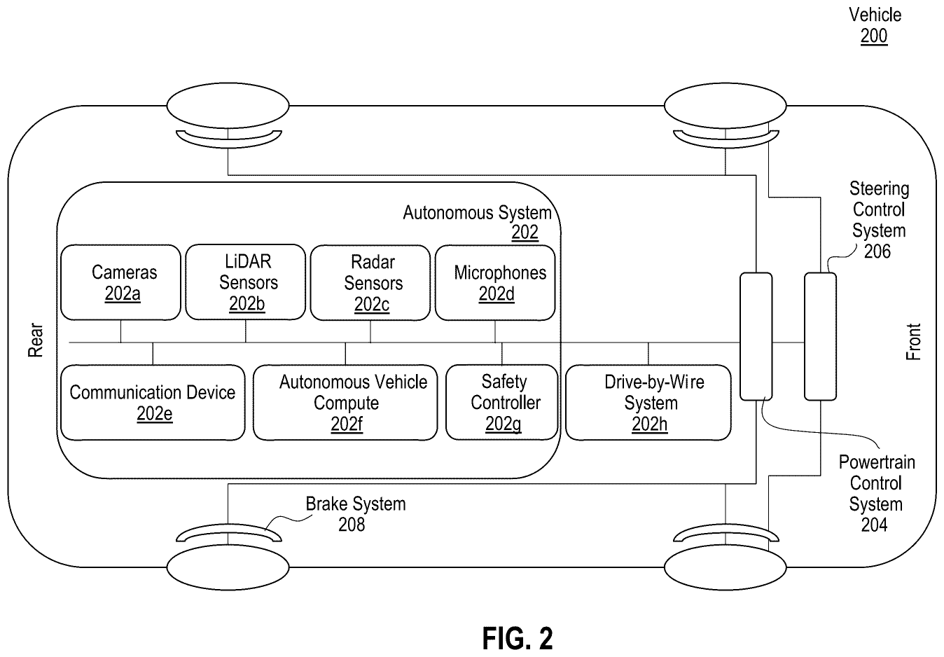

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle computer, software implemented by an autonomous vehicle computer, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

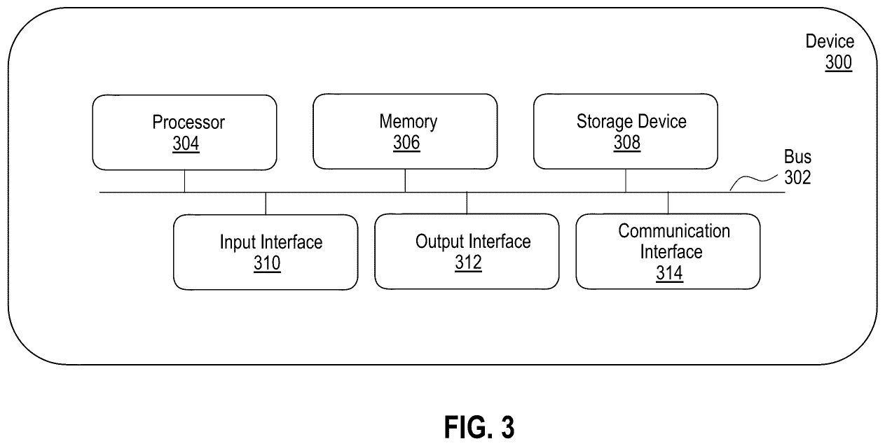

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments, autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle compute 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of the vehicle 200 (e.g., at least one device of a system of the vehicle 200), and/or one or more devices of network 112 (e.g., one or more devices of a system of network 112). In some embodiments, one or more devices of vehicles 102 (e.g., one or more devices of a system of vehicles 102), one or more devices of vehicle 200, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

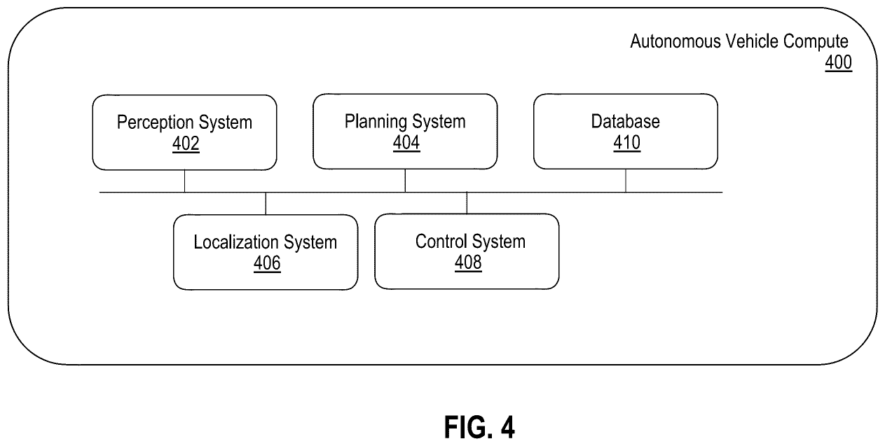

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, the perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle (i.e. coordinates) in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

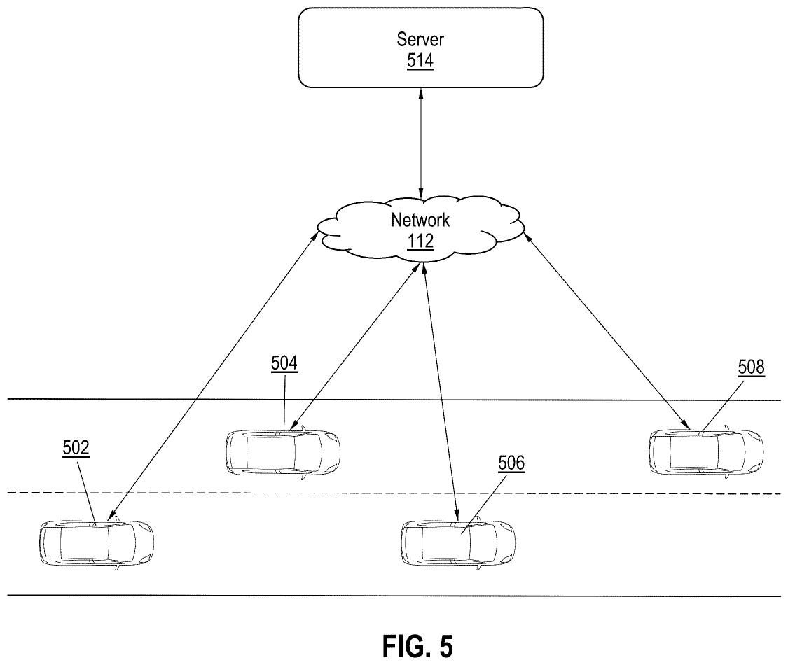

FIG. 5 depicts an example embodiment of a system configured to aggregate processed data of various geographical areas. The aggregated data can be used, for example, for determining a trajectory of a vehicle within a physical space or generating one or more graphical representations for use by a display of a vehicle. In embodiments, FIG. 5 depicts a plurality of vehicles 502, 504, 506, and 508, each of which are communicatively coupled to one other and to a server 514 via, e.g., a network 112. In embodiments, the network 112 utilizes communication protocols that are based on, e.g., 5G, C-V2X, and so forth. Broadly speaking, each of the vehicles 502, 504, 506, and 508 may include a plurality of cameras disposed thereupon that are configured to capture images of various objects within a surrounding environment of each of these respective vehicles. For example, each of the vehicles 502, 504, 506, and 508 capture images of various objects, e.g., pedestrians, traffic lights, additional vehicles, constructions signs, and so forth, and store the captured data (e.g., image data) in various formats, e.g., RAW format, JPEG format, PNG format, and so forth, in the database 410 of each of these vehicles.

Further, each of the captured data is associated with a time stamp or a predefined time period. In embodiments, the data captured by the respective cameras of each of the vehicles 502, 504, 506, and 508 is further processed by the perception system 402 of the autonomous vehicle compute 400 (FIG. 4) that is included as part of each of the vehicles 502, 504, 506, and 508. The perception system 402 operates to classify one or more of the various objects within the surrounding environment of each of the vehicles based on various groupings, e.g., objects may be classified as bicycles, pedestrians, traffic lights, other vehicles, constructions signs, and so forth. In embodiments, the perception system 402 operates to convert the format of the image data associated with the captured images, e.g., RAW format, JPEG format, PNG format, and so forth, into numerical representations, e.g., float values, and store these float values in the database 410 of the autonomous vehicle compute 400. In embodiments, these float values are also routed by the autonomous vehicle compute 400 to the communication device 202e (included as part of each of the vehicles 502, 504, 506, and 508), which communicates these float values to other vehicles and/or the server 514, e.g., via the network 112. It is noted that the server 514 is the same as, or comparable to the remote autonomous vehicle (AV) system 114, a fleet management system, and/or a v2i system.

In an example operation of the system of the present disclosure, the communication device 202e of the vehicle 502 transmits a query directly to one or more of the vehicles 504, 506, and 508, via the network 112, to determine information regarding the areas surrounding the vehicles 504, 506, and 508. In particular, the query could include a request for information regarding objects that are present within a particular vicinity (e.g., 25-50 meters) of each of the vehicles 504, 506, and 508. In embodiments, the vehicle 502 transmits such a query to the server 514 via the network 112, which in turn transmits the query to each of the vehicles 504, 506, and 508. In response, a perception system installed in each of the vehicles 504, 506, and 508, captures image data of their respective surroundings, (e.g., within a proximity of 25-50 meters), classifies various objects included in the image data in accordance with various groupings (e.g., objects may be classified as bicycles, pedestrians, traffic lights, other vehicles, constructions signs, and so forth), and converts the format of the image data from, e.g., RAW format, JPEG format, PNG format, and so forth, to a numerical format such as float values. In embodiments, the generated float values are routed by the autonomous vehicle compute 400 from the perception system 402 to the communication device 202e installed in each of the vehicles 504, 506, and 508. In embodiments, the communication device 202e of each of the vehicles 504, 506, and 508 then transmits these float values, e.g., directly to the communication device 202e of the vehicle 502 (the query requesting vehicle) or to the communication device 202e via the server 514.

In embodiments, after the communication device 202e of the vehicle 502 receives the float values from each of the vehicles 504, 506, and 508, these values are routed to the perception system 402 and the database 410 of the vehicle 502. In embodiments, the perception system 402 converts the float values to various image formats, e.g., RAW format, JPEG format, PNG format, and so forth, and as such, is able to access information regarding various objects located in the vicinities (e.g., 25-50 meters) of each of the vehicles 504, 506, and 508. In embodiments, the perception system 402, operating independently or in conjunction with the planning system 404 operates to aggregate the image data of each of the vehicles 504, 506, and 508 together, in addition to aggregating the image data of each of the vehicles 504, 506, and 508 with that of the image data captured by the cameras of the vehicle 502. The aggregated data, which incorporates data of objects included in the surroundings of the vehicles 504, 506, and 508, and that of the vehicle 502, is then routed by the perception system 402 of the vehicle 502 to the planning system 404 of the vehicle 502. In embodiments, the transmission of the query by the vehicle 502, and the transmission and reception of data (e.g., float values) is performed using one or more Global System for Mobiles (“GSM”) module based internet devices.

In embodiments, the planning system 404 utilizes the aggregated image data to determine a trajectory of the vehicles 502 from a source to a destination location. Further, in embodiments, the vehicle 502 periodically transmits multiple such queries to the other vehicles (e.g., directly or via the server) in order to receive data (in the form of float values) of the surroundings of the vehicles 504, 506, and 506, at various locations along a particular determined trajectory. Based on responses to these periodic queries, the image data may be further aggregated, in approximately real time, by the perception system 402 and routed to the planning system 404, which in turn operates to plan a vehicle trajectory or modify an existing trajectory based on the aggregated data. In embodiments, the aggregated data is output, in approximately real time, on a display of the vehicle 502. In embodiments, it is noted that the vehicles 504, 506, and 508 may also transmit queries directly to other vehicles, aggregate data, and determine a trajectory in the manner similar to vehicle 502, as described above.

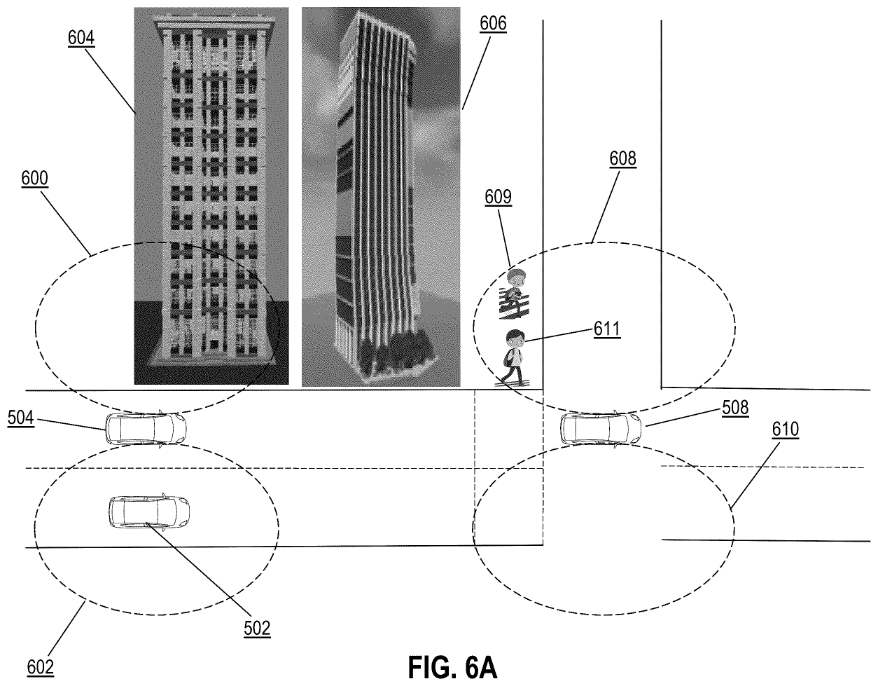

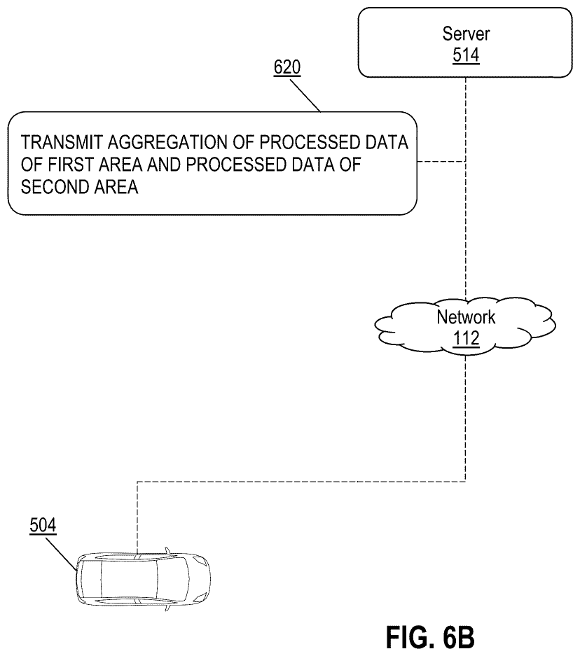

FIG. 6A depicts an example implementation of the system of the present disclosure in which two vehicles obtain and process data of different geographical areas, according to one or more embodiments described and illustrated herein. As illustrated, the vehicle 508 is displayed as travelling past a particular intersection adjacent to skyscrapers 604, 606. Further, the vehicle 508 includes multiple sensors (e.g., cameras) disposed on the outside of the vehicle 508 that obtain external environmental data by capturing images within a first range 608 and a second range 610, e.g., 25-50 meters surrounding the vehicle 508. It is noted that the values of 25-50 meters are for illustrative purposes only, as cameras could be designed to capture images that are closer or further away. As illustrated, in the first range 608, the vehicle 508 may capture images of children 609 and 611 that are situated at an intersection (e.g., a first area). It is noted that, due to the skyscrapers 604 and 606, the presence of these children 609 and 611 (e.g., a first object or first objects) are obscured by the skyscrapers 604 and 606.

After capturing the images, the vehicle 508 stores image data representative of these images locally in the database 410 of the autonomous vehicle compute 400 of the vehicle 508. In some embodiments, the cameras capture images in the form of a live video stream of the surrounding environment. In some embodiments, the perception system 402 of the vehicle 508 transforms the format of the captured images, which may be in, e.g., RAW format, JPEG format, PNG format, and so forth, into a numerical format such as float values, as described above. These float values represent, e.g., the dimensions of various objects in the images, color of the images, and other characteristics in a memory or resource-efficient manner. Thereafter, instead of transmitting the captured images, the vehicle 508 transmits the float values directly to the other vehicles 502, 504, and 506. In embodiments, the float values are transmitted to the server 514, which routes the float values to each of the vehicles 502, 504, and 506, via the network 112. In this way, the vehicle 508 shares data regarding various objects within a particular vicinity of the vehicle 508 to the server 514 and/or other vehicles.

In the example shown in FIG. 6A, the vehicle 504 illustrated as traveling behind the vehicle 508 operates in a manner that is similar to the operation of the vehicle 508. For example, the vehicle 504 includes one or more sensors, e.g., cameras, disposed on the exterior surface of the vehicle 504, which obtain data of the environment surrounding the vehicle 504 such as within a third range 600 and a fourth range 602, e.g., 25-50 meters surrounding the vehicle 508. The fourth range 602 may include another vehicle 502 (e.g., a second object) and the third range 600 may part of the skyscraper 604. In embodiments, the vehicle 504 stores data associated with the third range 600 and the fourth range 602 locally, e.g., in the database 410 of the vehicle 504. Thereafter, the perception system 402 of the vehicle 504 transforms the data of the environment surrounding the vehicle 504 from, e.g., RAW format, JPEG format, PNG format, and so forth, into a numerical format such as float values. These float values are transmitted by the vehicle 504 to each of the other vehicles 502, 506, and 508 directly or via the server 514, approximately in real time.

FIG. 6B depicts an example embodiment in which a vehicle 504 transmits a query to the server 514 in order to determine information regarding various objects that are present within a particular distance of a location, e.g., the location through which the vehicle 504 is travelling within a short time frame. In particular, the vehicle 504 may transmit an inquiry in order to determine the types of objects that are present in an area that is 50 meters in front of the vehicle 504. As illustrated in FIG. 6A, such an area may correspond to the location through which the vehicle 508 previously traveled. As such, the data transmitted by the vehicle 508 may include information that may assist the vehicle 504 in navigating effectively, namely information regarding the presence of the children that are beyond the visual range of the cameras of the vehicle 504.

Upon receiving the inquiry, the server 514 transmits the data received from the vehicle 508 to the vehicle 504, e.g., in real time. In some embodiments, upon receiving the inquiry, the perception system 402 of the vehicle 508 operates to transform the image data captured by one or more cameras of the vehicle 508 into float values, which are then routed from the perception system 402 to the communication device 202e of the vehicle 508. In embodiments, the communication device 202e of the vehicle 508 transmits the float values to the server 514, which then transmits these float values to the communication device 202e of the vehicle 504. In embodiments the vehicle 504 may also communicate image data that is captured by one or more of the cameras included in the vehicle 504 to the server 514. The server 514 then aggregates the float values received from the vehicle 504 and the vehicle 508 and transmits the aggregated float values (aggregated data 620) to the querying vehicle—the vehicle 504.

The aggregated data 620 is received by the communication device 202e of the vehicle 504 and routed to the perception system 402 of the autonomous vehicle compute 400 of the vehicle 504. As described above, the perception system 402 operates to convert the aggregated data 620 that is received (e.g., all of the float values associated with the vehicle 504 and the vehicle 508) into another image data format (e.g., RAW format, JPEG format, PNG format, and so forth). The data in the image format is routed to the planning system 404 of the vehicle 504. The planning system 404 utilizes the converted data to determine a trajectory of the vehicle 504 within a physical space, modify an existing trajectory, and/or generate a high definition map and uses this map for navigation. In some embodiments, the map is output on a display included in the interior of the vehicle 504. In embodiments, it is noted that each of the high definition maps generated by each of the vehicles are stored in the server 514.

Alternatively, the communication device 202e of the vehicle 508 transmits the float values directly to the communication device 202e of the other vehicle 504 (e.g., the querying vehicle). The vehicle 504, which receives the float values from the vehicle 508, utilizes the perception system 402 to convert the float values received from the vehicle 508 into image data corresponding to an image format and aggregate the converted image data with the image data captured by one or more cameras of the vehicle 504. In this way, in this embodiment, the vehicle 504 generates aggregated data 620, which includes image data from both of the vehicles 504 and 508. Thereafter, as described above, aggregated data 620 is routed from the perception system 402 to the planning system 404, which utilizes the converted data to determine a trajectory of the vehicle 504 within a physical space, modify an existing trajectory, and/or generate a high definition map and uses this map for navigation.

It is noted that the respective locations of the vehicle 504 and the vehicle 508 are identifiable with the use of GPS. For example, both the vehicles 504 and 508 identify their respective locations using GPS and operate such that they communicate their respective locations to each other, to other vehicles, the server 514, and so forth. In embodiments, the one or more locations of each of the vehicles 504 and 508 may be broadcast, e.g., at preset intervals, throughout the time that the vehicles 504 and 508 are traveling. Further, these locations are broadcast (e.g., at preset intervals or approximately in real time) to the server 514 that operates a publisher/subscriber software application.

In embodiments, operators associated with the vehicles may purchase a subscription to the publisher/subscriber software application, which enables the subscribing vehicles to access image data (e.g., float values) associated with the surroundings of a plurality of vehicles traveling at various location in approximately real time. In this way, the publisher/subscriber software operates as part of a platform that enables for the aggregation (unification) of data (e.g., float values) to augment current data (e.g., map data) generated by a particular vehicle. These vehicles operate to transmit data (e.g., float values) that are representative of image data of various objects within a particular vicinity of each of these vehicles to the server 514 and/or other vehicles. A particular vehicle then accesses data of the surrounding areas of all other vehicles traveling at various locations. Further, in embodiments, the publisher/subscriber software application operating as part of a platform (e.g., a common application programming interface or (“API”)) that enables for the sharing of image data in a unified data structure, namely in the form of float values representing data of objects, maps, and so forth. It is noted that the operations described in the present disclosure can be performed using the autonomous vehicle compute 400 and without the use of additional computing devices onboard each of these vehicles.

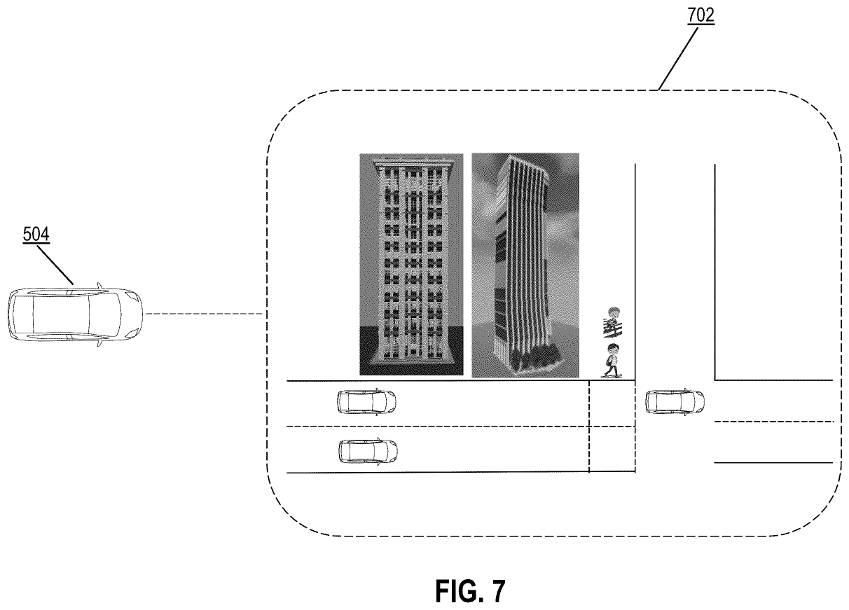

FIG. 7 depicts an example of a high definition map that is generated and output on a display 702 included within the vehicle 504. In embodiments, after receipt of the aggregated data 620, the processor 304 of the vehicle 504 may perform one or more transformation operations on the float values included in the aggregated data 620, including converting the format of these float values to, e.g., a RAW format, JPEG format, or PNG format, which is representative of images, video streams, and so forth. As stated above, such a conversion may be performed by the perception system 402 of the vehicle 504. After such a conversion, the converted data is utilized by autonomous vehicle compute 400 to generate and output a high definition map on the display 702. As illustrated, the map output on the display 702 may include the skyscrapers 604 and 606, the vehicle 504, and the children 609 and 611, at the intersection. As such, the vehicle 504 may now be aware that the intersection is a busy intersection and/or that such an area has a likelihood of collision with pedestrians that is above a particular threshold.

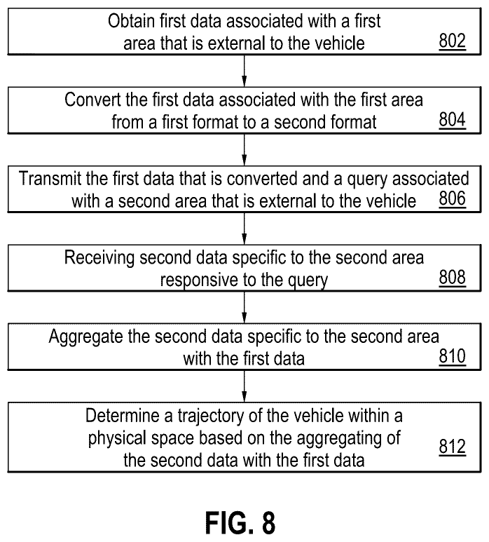

Referring now to FIG. 8, illustrates a flowchart of a process for aggregating processed data of various geographical areas for the purpose of determining a trajectory of a vehicle within a physical space and generating one or more graphical representations for use by a display of the vehicle. In some embodiments, one or more of the steps described with respect to the process are performed (e.g., completely, partially, and/or the like) by the autonomous vehicle compute 400. Additionally, or alternatively, in some embodiments one or more steps described with respect to process are performed (e.g., completely, partially, and/or the like) by another device or group of devices separate from or including the autonomous vehicle compute 400.

In particular, in block 802, a first data associated with a first area that is external to a vehicle is obtained. In embodiments, the vehicle 200 utilizes the cameras 202a to obtain first data associated with the first area that is external to the vehicle. The vehicle 200 is the same as, or similar to, vehicle 102a of FIG. 1.

In block 804, the first data that is associated with the first area is converted from a first format to a second format. The first format may correspond to, e.g., JPEG, Raw, PNG format, and so forth, and the second format may correspond to a numerical representations, e.g., float values. It is noted that other representations for each of the first format and the second format are also contemplated. The perception system 402 of the autonomous vehicle compute 400, which is included as part of the vehicle 200, may perform the conversion of the first data from a first format to a second format.

In block 806, the first data that is converted and a query associated with a second area that is external to the vehicle is transmitted, to a server (e.g., the remove AV system 114, the fleet management system 116, and/or the vehicle-to-system infrastructure system 118), or directly to another vehicle. For example, the vehicle 102a may transmit, to a server or directly to another vehicle (e.g., vehicle 102b), float values representative of various objects within a proximity of the vehicle (e.g., the vehicle 102a) and a query to determine information regarding various objects that are present in an area that is outside of or beyond the visual range of the cameras of the other vehicle (e.g., the vehicle 102b). In embodiments, the transmission of the query and the first data that is converted may be performed by the communication device 202e included as a part of the autonomous system 202 of the vehicle 200. It is noted that the vehicle 200 is the same as or similar to the vehicles illustrated in FIG. 1, e.g., 102a, 102b, and so forth.

In embodiments, the query associated with the second area is a request for a mapping of an environment within a particular proximity of the other vehicle. Such information may enable the vehicle to navigate through the second area in a manner that enables collision avoidance, and so forth. In embodiments, it is noted that a first distance associated with the first area relative to the vehicle of block 802 is less than a second distance associated with a second area, which may be associated with the other vehicle (e.g., a second vehicle). For example, a first vehicle could be traveling at a particular location on a street and capture images of various objects within a proximity of the first vehicle, and communicate a query to a second vehicle that is travelling, e.g., 50 meters in front of the first vehicle, for the purposes of determining information about various objects such as individuals, other vehicles, and so forth, in an area that is inaccessible to the cameras of the first vehicle.

In block 808, the vehicle may receive second data specific to the second area in response to the query. In particular, the communication device 202e of the vehicle 200, illustrated in FIG. 2, may receive float values describing various objects present in the area that is beyond the visual range of the cameras of the vehicle, e.g., the area regarding which the query was sent. In embodiments, the vehicle receives this information directly from another vehicle or from the server.

In block 810, the vehicle may aggregate the second data specific to the second area with the first data, which is stored in the database of the vehicle. In embodiments, it is noted that the step of aggregation of the first data and the second data be performed by the server, which may transmit the aggregated first data and the second data to the vehicle. Alternatively, the step of aggregation of the first data and the second data is performed by a querying vehicle (e.g., a first vehicle), which receives data in the form of float values from a second vehicle. In embodiments, the first vehicle may convert the float values received from the second vehicle into an image data format, and aggregate it with the image data captured by one or more cameras of the first vehicle. The aggregated image data is then routed by the first vehicle to, e.g., a planning system of the first vehicle.

In block 812, a trajectory of the vehicle (e.g., the vehicle 200 of FIG. 2 that corresponds to the vehicle 102a, 102b, and so forth, of FIG. 1) within a physical space based on the aggregating of the second data and the first data is determined by the planning system 404 of the autonomous vehicle compute 400, which corresponds to the autonomous vehicle compute 202f of the vehicle 200. In embodiments, the aggregation of the first data and the second data is utilized by the planning system 404 of the autonomous vehicle compute 400 of the vehicle to determine particular routes from a source to a destination location, modify existing routes in order to avoid collisions, and so forth.

Further, the aggregation of the second data and the first data is utilized by the planning system 404 to generate a graphical representation for use by a display of the vehicle (e.g., the vehicle 102a, 102b, and so forth). For example, upon receipt of the float values corresponding to the second area, the vehicle, e.g., the perception system 402 of the vehicle, may convert these float values to an image format, e.g., JPEG, Raw, PNG format, and so forth, and combine the information with image data that the vehicle originally captured. Based on this combination, the planning system 404 of the vehicle may generate a high definition map that includes objects that are beyond the visual range of the cameras of the vehicle. In embodiments, an example graphical representation includes a first object derived from data associated with the first are and a second object derived from the second data specific to the second area. In embodiments, the graphical representation may be a high definition digital map that is output on a display of the first vehicle.

In embodiments, the high definition digital map, displays various objects in the first area and various additional objects included in the second area as part of the same map. In other embodiments, the display of the vehicle may include a user interface in which routes are illustrated on the user interface adjacent to these objects. Other variations of the user interface are also contemplated. It is noted that the objects may include, e.g., pedestrians, traffic lights, additional vehicles, constructions, and a plurality of other points of interest such as restaurants, grocery stores, and so forth. Data associated with each of these objects may be output on the display of the vehicles. It is further noted that the numerical representations, described in block 804, and which correspond to various float values, represent various characteristics of the objects described above. For example, the float values describe dimensions of various objects, e.g., one or more of a width, length, height, and so forth. Also, if one or more of these objects are other vehicles, the characteristics also correspond to velocity, acceleration, and so forth, of these vehicles. In embodiments, orientation information, classification information (e.g., whether the object is a human or machine, static or in motion, and so forth), and coordinates are also captured by the float values.

According to some non-limiting embodiments or examples, provided is a method comprising:

obtaining, using at least one processor, from at least one sensor of a vehicle, first data associated with a first area that is external to the vehicle;

converting, using the at least one processor, the first data associated with the first area from a first format to a second format;

transmitting, using the at least one processor, to a server that is external to the vehicle, the first data that is converted and a query associated with a second area that is external to the vehicle;

receiving, using the at least one processor, from the server, second data specific to the second area responsive to the query;

aggregating, using the at least one processor, the second data specific to the second area with the first data; and

determining, using the at least one processor, a trajectory of the vehicle within a physical space based on the aggregating of the second data with the first data.

According to some non-limiting embodiments or examples, provided is system comprising at least one processor of a vehicle and at least one non-transitory storage media storing instructions that, when executed by the at least one processor, cause the at least one processor to perform operations comprising:

obtaining, using the at least one processor, from at least one sensor of a vehicle, first data associated with a first area that is external to the vehicle;

converting, using the at least one processor, the first data associated with the first area from a first format to a second format;

transmitting, using the at least one processor, to a server that is external to the vehicle, the first data that is converted and a query associated with a second area that is external to the vehicle;

receiving, using the at least one processor, from the server, second data specific to the second area responsive to the query;

aggregating, using the at least one processor, the second data specific to the second area with the first data; and

determining, using the at least one processor, a trajectory of the vehicle within a physical space based on the aggregating of the second data with the first data.

Further non-limiting aspects or embodiments are set forth in the following numbered clauses:

Clause 1: A method comprising: obtaining, using at least one processor, from at least one sensor of a vehicle, first data associated with a first area that is external to the vehicle; converting, using the at least one processor, the first data associated with the first area from a first format to a second format; transmitting, using the at least one processor, to a server that is external to the vehicle, the first data that is converted and a query associated with a second area that is external to the vehicle; receiving, using the at least one processor, from the server, second data specific to the second area responsive to the query; aggregating, using the at least one processor, the second data specific to the second area with the first data; and determining, using the at least one processor, a trajectory of the vehicle within a physical space based on the aggregating of the second data with the first data.

Clause 2: The method of clause 1, further comprising generating a graphical representation for use by a display of the vehicle based on the second data that is aggregated with the first data, the graphical representation comprising a first object derived from data associated with the first area and a second object derived from the second data specific to the second area, wherein the graphical representation is a digital map that is generated based on the first area and the second area.

Clause 3: The method of clause 2, further comprising: outputting the graphical representation on the display, the outputting comprising outputting the digital map to include the first object and the second object.

Clause 4: The method of clause 3, further comprising: receiving third data specific to the second area; and updating the graphical representation to include a third object that is derived from the third data.

Clause 5: The method of any of clauses 1-5, wherein: the at least one sensor is a camera; and wherein the obtaining of the first data associated with the first area that is external to the vehicle comprises capturing, by the camera, at least one image within a proximity of the vehicle in the first area that is external to the vehicle.

Clause 6: The method of any of clauses 1-6, wherein the first format corresponds at least one of a RAW format, JPEG format, or PNG.

Clause 7: The method of any of clauses 1-6, wherein the second format corresponds to float values.

Clause 8: The method of clause 7, wherein: the obtaining of the first data associated with the first area that is external to the vehicle comprises: capturing, by a camera, at least one image within a proximity of the vehicle in the first area that is external to the vehicle, wherein the float values are representative of characteristics of objects included in the at least one image.

Clause 9: The method of clause 8, wherein the objects include one or more of pedestrians, traffic lights, additional vehicles, and constructions signs.

Clause 10: The method of clause 8, wherein the characteristics of the objects comprise one or more of a width, length, height, velocity, acceleration, orientation, classification, and coordinates associated with the objects.

Clause 11: A system, comprising: at least one processor of a vehicle, and at least one non-transitory storage media storing instructions that, when executed by the at least one processor, cause the at least one processor to perform operations comprising: obtaining, using the at least one processor, from at least one sensor of a vehicle, first data associated with a first area that is external to the vehicle; converting, using the at least one processor, the first data associated with the first area from a first format to a second format; transmitting, using the at least one processor, to a server that is external to the vehicle, the first data that is converted and a query associated with a second area that is external to the vehicle; receiving, using the at least one processor, from the server, second data specific to the second area responsive to the query; aggregating, using the at least one processor, the second data specific to the second area with the first data; and determining, using the at least one processor, a trajectory of the vehicle within a physical space based on the aggregating of the second data with the first data.

Clause 12: The system of clause 11, wherein the query associated with the second area is a request for a mapping of an environment associated with the second area and the first area is at a first distance relative to the vehicle and the second area is at a second distance relative to the vehicle, wherein the second distance is larger than the first distance.

Clause 13: The system of clause 11 or clause 12, wherein the operations further comprise: generating a graphical representation for use by a display of the vehicle based on the second data that is aggregated with the first data, the graphical representation comprising a first object derived from data associated with the first area and a second object derived from the second data specific to the second area, wherein the graphical representation is a digital map that is generated based on the first area and the second area; and outputting the graphical representation on the display, the outputting comprising outputting the digital map to include the first object and the second object.

Clause 14: The system of any of clauses 11 to 13, wherein the operations further comprise: receiving third data specific to the second area; and updating the graphical representation to include a third object that is derived from the third data.

Clause 15: The system of any of clauses 11 to 14, wherein: the at least one sensor is a camera; and wherein the obtaining of the first data associated with the first area that is external to the vehicle includes capturing, by the camera, at least one image within a proximity of the vehicle in the first area that is external to the vehicle.

Clause 16: The system of any of clauses 11-15, wherein the first format corresponds to at least one of a RAW format, JPEG format, or PNG.

Clause 17: The system of any of clauses 11-16, wherein the second format corresponds to float values.

Clause 18: The system of clause 17, wherein one of the operations of the obtaining of the first area that is external to the vehicle comprises: capturing, by a camera, at least one image within a proximity of the vehicle in the first area that is external to the vehicle, wherein the float values are representative of characteristics of objects included in the at least one image.

Clause 19: The system of clause 18, wherein the objects include one or more of pedestrians, traffic lights, additional vehicles, and constructions signs.

Clause 20: The system of clause 18, wherein the characteristics of the objects comprise one or more of a width, length, height, velocity, acceleration, orientation, classification, and coordinates associated with the objects.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
obtaining, using at least one processor, from at least one sensor of a vehicle, first data associated with a first area that is external to the vehicle;
converting, using the at least one processor, the first data associated with the first area from a first format to a second format;
transmitting, using the at least one processor, to an additional vehicle that is external to the vehicle, the first data that is converted and a query associated with a second area that is external to the vehicle;
receiving, using the at least one processor, second data specific to the second area responsive to the query;
aggregating, using the at least one processor, the second data specific to the second area with the first data; and
determining, using the at least one processor, a trajectory of the vehicle within a physical space based on the aggregating of the second data with the first data.

2. The method of claim 1, further comprising generating a graphical representation for use by a display of the vehicle based on the second data that is aggregated with the first data, the graphical representation comprising a first object derived from data associated with the first area and a second object derived from the second data specific to the second area, wherein the graphical representation is a digital map that is generated based on the first area and the second area.

3. The method of claim 2, further comprising:
outputting the graphical representation on the display, the outputting comprising outputting the digital map to include the first object and the second object. data.

4. The method of claim 3, further comprising:
receiving third data specific to the second area; and
updating the graphical representation to include a third object that is derived from the third data.

5. The method of claim 1, wherein:
the at least one sensor is a camera; and
wherein the obtaining of the first data associated with the first area that is external to the vehicle comprises capturing, by the camera, at least one image within a proximity of the vehicle in the first area that is external to the vehicle.

6. The method of claim 1, wherein the first format corresponds at least one of a RAW format, JPEG format, or PNG format.

7. The method of claim 1, wherein the second format corresponds to float values.

8. The method of claim 7, wherein:
the obtaining of the first data associated with the first area that is external to the vehicle comprises:
capturing, by a camera, at least one image within a proximity of the vehicle in the first area that is external to the vehicle, wherein the float values are representative of characteristics of objects included in the at least one image.

9. The method of claim 8, wherein the objects include one or more of pedestrians, traffic lights, additional vehicles, and constructions signs.

10. The method of claim 8, wherein the characteristics of the objects comprise one or more of a width, length, height, velocity, acceleration, orientation, classification, and coordinates associated with the objects.

11. A system, comprising:
at least one processor of a vehicle, and
at least one non-transitory storage media storing instructions that, when executed by the at least one processor, cause the at least one processor to perform operations comprising:
obtaining, using the at least one processor, from at least one sensor of the vehicle, first data associated with a first area that is external to the vehicle;
converting, using the at least one processor, the first data associated with the first area from a first format to a second format;
transmitting, using the at least one processor, the first data that is converted and a query associated with a second area that is external to the vehicle;
receiving, using the at least one processor, second data specific to the second area responsive to the query;
aggregating, using the at least one processor, the second data specific to the second area with the first data; and
determining, using the at least one processor, a trajectory of the vehicle within a physical space based on the aggregating of the second data with the first data.

12. The system of claim 11, wherein the query associated with the second area is a request for a mapping of an environment associated with the second area and the first area is at a first distance relative to the vehicle and the second area is at a second distance relative to the vehicle, wherein the second distance is larger than the first distance.

13. The system of claim 11, wherein the operations further comprise:
generating a graphical representation for use by a display of the vehicle based on the second data that is aggregated with the first data, the graphical representation comprising a first object derived from data associated with the first area and a second object derived from the second data specific to the second area, wherein the graphical representation is a digital map that is generated based on the first area and the second area; and
outputting the graphical representation on the display, the outputting comprising outputting the digital map to include the first object and the second object. data.

14. The system of claim 13, wherein the operations further comprise:
receiving third data specific to the second area; and
updating the graphical representation to include a third object that is derived from the third data.

15. The system of claim 11, wherein:
the at least one sensor is a camera; and
wherein the obtaining of the first data associated with the first area that is external to the vehicle includes capturing, by the camera, at least one image within a proximity of the vehicle in the first area that is external to the vehicle.

16. The system of claim 11, wherein the first format corresponds to at least one of a RAW format, JPEG format, or PNG format.

17. The system of claim 11, wherein the second format corresponds to float values.

18. The system of claim 17, wherein one of the operations of the obtaining of the first area that is external to the vehicle comprises:
capturing, by a camera, at least one image within a proximity of the vehicle in the first area that is external to the vehicle, wherein the float values are representative of characteristics of objects included in the at least one image.

19. The system of claim 18, wherein the objects include one or more of pedestrians, traffic lights, additional vehicles, and constructions signs.

20. The system of claim 18, wherein the characteristics of the objects comprise one or more of a width, length, height, velocity, acceleration, orientation, classification, and coordinates associated with the objects.
